(19) United States
(12) Patent Application Publication
(10) Pub. No.: US 2016/0294228 A1
(43) Pub. Date: Oct. 6, 2016

(54) ELECTRIC MOTOR

(71) Applicant: SOCIETE INDUSTRIELLE DE SONCEBOZ SA, Sonceboz (CH)

(72) Inventors: Christophe DEXET, Damprichard (FR); Hubert POINCEAU, Bienne (CH)

(73) Assignee: SOCIETE INDUSTRIELLE DE SONCEBOZ SA, Sonceboz (CH)

(21) Appl. No.: 15/037,666

(22) PCT Filed: Nov. 13, 2014
(86) PCT No.: PCT/EP2014/074459

§ 371 Date: May 18, 2016

(30) Foreign Application Priority Data
Nov. 19, 2013 (EP) 13193577.7

(51) Int. Cl. H02K 1/08

(52) U.S. Cl. CPC H02K 1/08

(57) ABSTRACT

The invention relates to an electric motor including a rotor (2) including a magnetised part (3) defining a plurality of rotor poles, and a stator (4) including a plurality of coils (8) and a magnetic armature (6) defining a magnetic circuit. Each coil comprises a coil core (14) in the form of an attached part made of a magnetic material fastened to the magnetic armature, the coil core including a tooth defining a magnetic pole of the stator. The tooth comprises extensions (6a, 16b) extending in an axial direction, a height H′ of the tooth and a height H of the coil being comparable to a height H″ of the magnetised part of the rotor.

The present invention concerns the field of electric motors and particularly flat electric motors, for example for applications in the field of medical devices.

Flat electric motors are for example described in the patent publications and patent applications U.S. Pat. No. 5,708,406, U.S. Pat. No. 8,084,913, EP1482626 US2010/0314962. Motors with a magnetic armature where the coil cores are attached are known and described in US2009/0001824, US2002/0135243, JP2002-315295A or in JP2011-223776A for example.

The torque density of known flat motors is insufficient for some applications and/or the motor is expensive to manufacture and/or is insufficiently reliable.

A subject of the invention is to provide a compact, effective and reliable electric motor.

It is advantageous to provide a flat electric motor with a high torque density for its size.

It is advantageous to provide an electric motor with a high efficiency.

It is advantageous to provide an electric motor that is cheap to manufacture.

In the present invention, an electrical motor is described comprising a rotor comprising a magnetized part defining a plurality of rotor poles, and a stator comprising a plurality of coils and a magnetic armature defining a magnetic circuit. Each coil comprises a coil core in the form of a separate preformed part made of a magnetic material fastened to the magnetic armature. The coil core comprises a tooth defining a magnetic pole of the stator, the tooth including extensions extending in an axial direction parallel to the axis of the rotor. The height of the tooth and the height of the coil are equal or nearly equal to the height of the magnetized part of the rotor.

According to a first aspect of the invention, the distance between adjacent coil poles is less than the maximum width of the coil.

According to a second aspect of the invention, the magnetic armature as well as the coil core are formed and cut out of metal sheets, a major plane of the metal sheets being perpendicular to the axis of rotation of the rotor, the extensions of the tooth being folded orthogonally on either side of the major plane.

According to a third aspect of the invention, the axial thickness of the core of the coil is less than half the axial thickness of the wound part (the part made of copper or another conductive material) of the coil.

According to a fourth aspect of the invention, the coil is assembled with its magnetic core axially in a recess of the magnetic armature, flanges of the coil support cooperating with edge parts of the recess to position the coil in the magnetic armature in the axial and radial directions (the radial direction being in a plane orthogonal to the axial direction.)

In an advantageous embodiment, free ends of the tooth have a smaller width than a central part of the tooth.

In an advantageous embodiment, the magnetic armature comprises two identical metal sheets assembled opposite one another.

In an advantageous embodiment, the ratio of the diameter of a circumscribed circle of the magnetic circuit to the height of the magnetized part of the rotor is greater than three.

In an advantageous embodiment, the ratio of the height of a magnetic tooth to the thickness of the main part of the magnetic armature is greater than three.

In an embodiment, the motor has two phases and comprises two coils and eight magnetic poles on the stator.

In an embodiment, the motor has two phases and comprises four coils and eight magnetic poles on the stator.

In an embodiment, the motor has three phases and comprises three coils and nine magnetic poles on the stator.

In an advantageous embodiment, the number of pairs of magnetic poles of the stator is greater than the number of pairs of magnetic poles of the rotor.

In an advantageous embodiment, the coil core and electrical terminals are overmolded with a coil support.

Other aims and advantageous aspects of the invention will become apparent on reading the claims and/or the following detailed description of embodiments of the invention in relation to the figures, wherein:

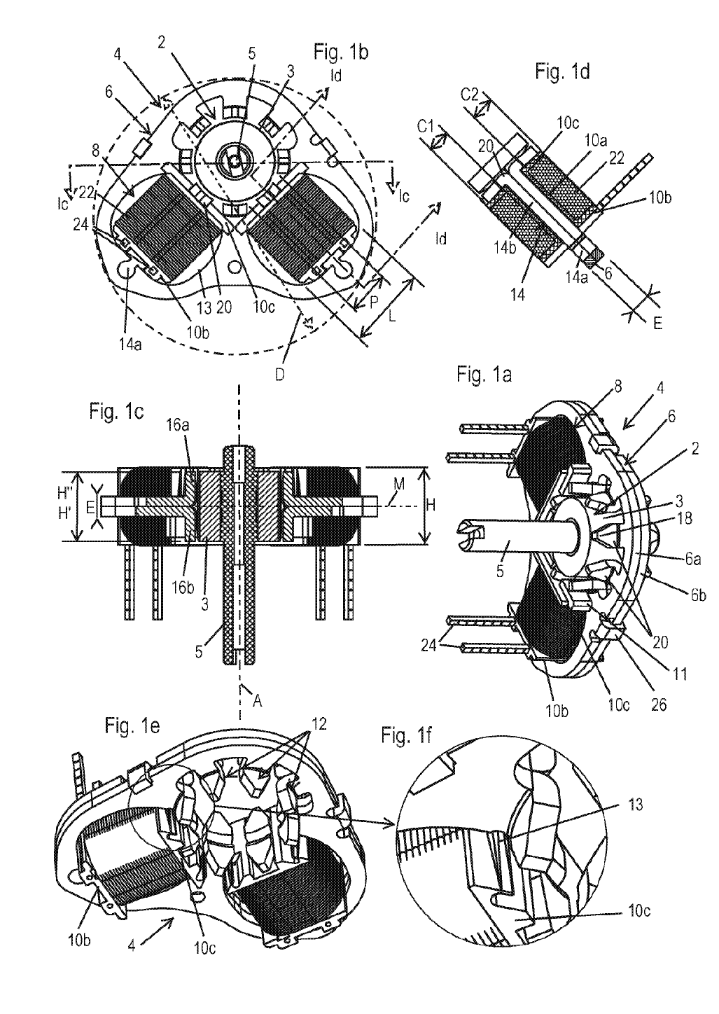

FIG. 1a is a perspective view of a first embodiment of an electric motor (illustrated without a housing) according to the invention;

FIG. 1b is a top view of the motor in FIG. 1a;

FIGS. 1c and 1d are section views along the lines Ic-Ic and Id-Id of FIG. 1b respectively;

FIG. 1e is a perspective view of the first embodiment (illustrated without housing) and without a rotor;

FIG. 1f is a perspective detail view of a part of FIG. 1e;

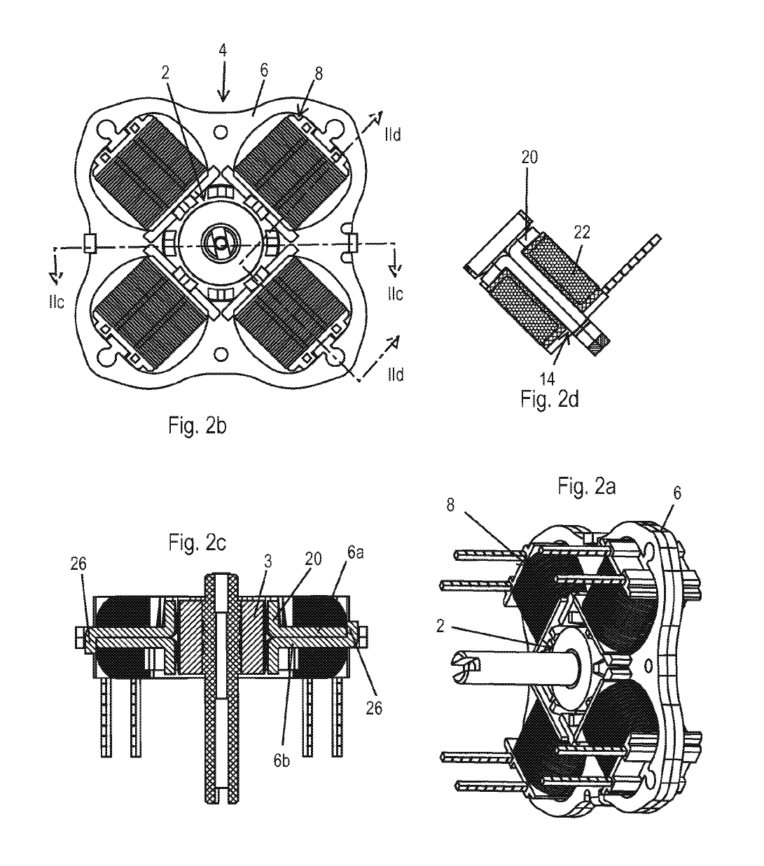

FIG. 2a is a perspective view of a second embodiment of an electric motor (illustrated without a housing) according to the invention;

FIG. 2b is a top view of the motor in FIG. 2a;

FIGS. 2c and 2d are section views along the lines IIc-IIc and IId-IId of FIG. 2b respectively;

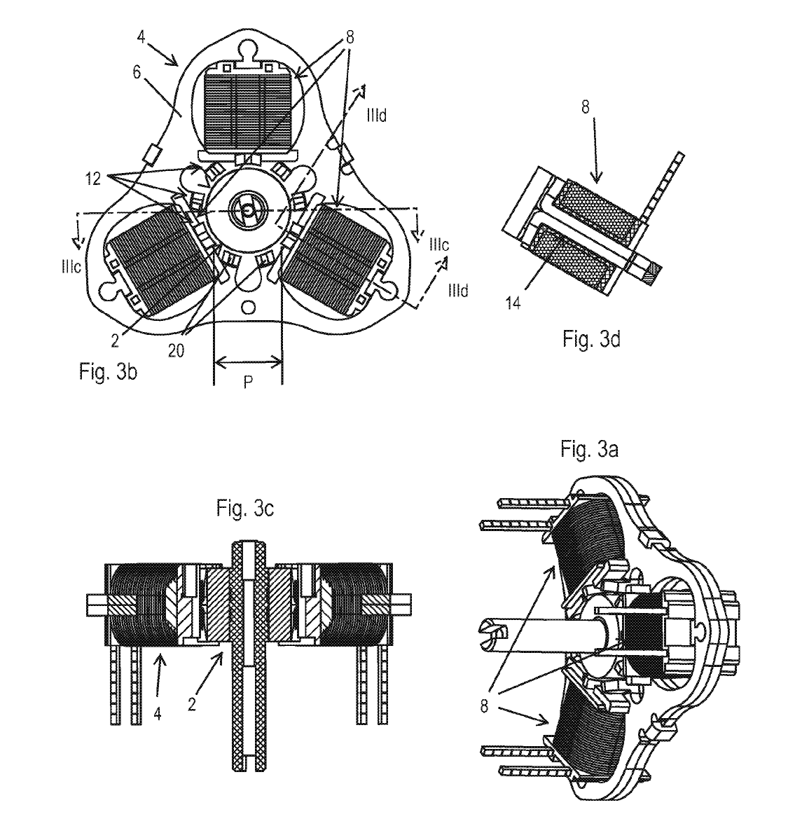

FIG. 3a is a perspective view of a third embodiment of an electric motor (illustrated without a housing) according to the invention;

FIG. 3b is a top view of the motor in FIG. 3a;

FIGS. 3c and 3d are section views along the lines IIIc-IIIc and IIId-IIId of FIG. 3b respectively;

With reference to the figures, an electric motor, according to various embodiments of the invention, comprises a rotor 2 and a stator 4 comprising coils 8 and a magnetic armature 6. The rotor comprises a magnetized part 3 defining a plurality of rotor poles. The rotor turns about an axis defining an axial direction A. FIGS. 1a-1f illustrate a two-phase motor comprising two coils and eight magnetic poles on the stator. FIGS. 2a-2d illustrate a two-phase motor comprising four coils and eight (four pairs) of magnetic poles on the stator. This embodiment is very advantageous since on one the hand it offers increased performance compared to the stator with two coils and, in the case of a solution with cut and folded metal sheets, it offers more space for cutting the metal sheets of the magnetic armature. FIGS. 3a-3d illustrate a three-phase motor comprising three coils and nine magnetic poles on the stator. The reference numbers appearing on FIGS. 1a to 1d are also applicable to the corresponding features of FIGS. 2a to 2d and 3a to 3d.

The magnetized part of the rotor can include an axial magnet coupled to a body made of a magnetic material comprising teeth forming poles. The term “magnetic material” is understood to mean a material with a high magnetic permeability such as a soft iron, a ferrite, or other materials used for the magnetic circuits of motors or electromagnetic transducers.

In a variant, the magnetized part of the rotor can be in the form of a ring magnet with circumferential sectors with alternating North/South magnetization, or else a ring to which magnets are attached, for example magnets made of sintered NdFeB.

The stator comprises a plurality of stator poles 12 which can be of an equal or different number to the number of poles of the rotor. The poles can form pairs of magnetic poles. In an advantageous embodiment, the number of magnetic poles of the stator is greater than the number of magnetic poles of the rotor. For example, the number of pairs of poles of the rotor can be 3 or 5 and the number of poles of the stator can be 8 or 9. For motors of small sizes, 3 pairs of poles on the rotor surprisingly give better results than 5 pairs of poles on the rotor. The magnetic armature 6 of the stator can advantageously have a generally flat shape, the major plane M of the flat shape oriented substantially perpendicularly to the axis of rotation A. The periphery of the flat shape can constitute a closed magnetic circuit surrounding the coils and the magnetized part of the rotor.

In an advantageous embodiment, the magnetic armature comprises several assembled parts, including at least a first part 6a and a second part 6b. The first and second parts can advantageously be manufactured from stamped metal sheets. In the illustrated embodiments, both parts 6a, 6b are of identical shape, configured to be assembled with opposite orientations, thus reducing the tooling and the manufacturing costs. Folded tabs 26 received in complementary hollows on the outer edges of the metal sheet make it possible to position and/or fasten the metal sheets together. In variants, other methods known per se for positioning and fastening the metal sheets together can be used, for example clipping, partial cutting, bonding, or welding. The stator comprises teeth 20 circumferentially distributed around the rotor and separated from the surface of the rotor by an air gap. The teeth define magnetic poles 12 of the stator. Certain teeth are coupled with the coils directly, and others are coupled indirectly via the magnetic circuit formed by the magnetic armature 6.

Each coil 8 comprises a coil support 10, for example made of a dielectric material such as molded or injected plastic, with a hollow central part 10a bordered by a first flange 10b at one end and a second flange 10c at the other end. A conductive wire 22 (made of copper or another conductive material) is wound on the hollow central part between the flanges and connected at its ends to electrical terminals 24, for example in the form of pins, assembled on the support, for example by overmolding in one of the flanges. The flanges 10b, 10c of the coil support 10 can advantageously also serve to guide, position and/or fasten the coil 8 to the magnetic armature 6. In the illustrated embodiments, the coil assembled with its magnetic core is advantageously inserted axially into a recess 13 of the magnetic armature 6. In an advantageous variant, the coil support 10, or a part of the coil support, can be overmolded on the core, with or without the electrical connection terminals.

The flange 10c comprises an axial-positioning limit stop 11 which bears on the armature in the assembled position. The edges of the flanges can also form axial and/or radial rails cooperating with edge parts of the recess 13 to position the coil in the radial plane (the radial plane being orthogonal to the axial direction A.) The flange 10c thus ensures the axial positioning, via a limit stop and, in some realizations, can also comprise a locking or holding clip. The flange 10c can advantageously also ensure positioning in the radial direction in order to guarantee the proper angular position of the pole, vis-a-vis the magnet of the rotor. Together, these functions also ensure better mechanical resistance, especially to vibrations and shocks.

The magnetic circuit of the stator further comprises a coil core 14, in the form of a separate preformed part made of a magnetic material, inserted into the center of each coil, in particular inserted into the hollow central part of the coil support. The coil core 14 comprises a fastening part 14a, a central part 14b, and a pole part which forms a tooth 20 forming a pole of the stator. The fastening part 14a is configured to be anchored to the armature 6, for example by welding, by riveting, by driving-out or by other mechanical means to establish a magnetic connection and a mechanical fastening with the armature. The provision of the coil core as a separate preformed part advantageously makes it possible to insert the coil core into the coil 10 before assembling the coil in the armature 6. This makes it possible to have a coil of greater dimensions (circumference/diameter/height/width) than in a configuration where the coil would have to be threaded around a core entirely formed with the magnetic armature. The coil core 14 can be made of the same material and by the same fabrication method as those used for the armature, for example by stamping of metal sheets. In the latter example, the core can even be formed and cut out of the piece of metal sheet forming the armature, thus making it possible to reduce material waste and tooling costs.

In some variants, the coil core can however also be made of a different material or by a different manufacturing method than those used for the magnetic armature.

In the illustrated embodiments, teeth 20 are advantageously joined with the stamped metal sheets of the magnetic armature 6 to form a single whole.

Each tooth comprises an axial extension 16a, 16b extending in the axial direction on either side of a median plane defining the interface between the two parts 6a, 6b of the armature. If the armature is made from stamped metal sheets, the extensions 16a projecting from one side are folded and extend axially from one of the parts 6a of the armature and the extensions 16b projecting from the other side are folded and extend axially from the other of the parts 6b of the armature. This advantageously makes it possible to obtain a compact and effective motor which is also cheap to make.

The free end 18 of each tooth 20 can have a shape with a reduced cross section, for example a chamfer, thus advantageously making it possible to have a tooth height H′ identical or similar to the height H of the coils while stamping the teeth of the metal sheet part in the area of the rotor. The height H′ of the teeth is greater than the thickness E of the main part of the magnetic armature and basically corresponds to the height H of the coils as well as the height of the magnetic poles of the rotor. In advantageous embodiments, the ratio of the height H′ of a tooth to the thickness E of the main part of the magnetic armature is greater than three: ratio H′/E>3.

The coils are as large as the height H″ of the magnetized part of the rotor allows, and the magnetic coupling between the stator and the rotor is optimized by having stator teeth of an axial height as large as the magnetized part of the rotor. According to an aspect of the invention, the axial height of the cross section of the coil filled with conductive wire, C1 plus C2, is more than twice the axial thickness E of the core of the coil: C1+C2>2*E. This configuration makes it possible to obtain a greater motor torque density with a motor of small height (in the axial direction A).

In advantageous embodiments, the ratio of the diameter D of the circumscribed circle of the magnetic circuit to the height H″ of the magnetized part is greater than three: D/H″>3. In some variants, for reasons other than torque production, for example for a sensor function, it can be necessary to extend the axial length of the rotor magnet, and in this case, it is the ratios D/H and/or D/H′ that can be greater than three.

According to an aspect of the invention, the winding width L (direction tangential to the air gap) is greater than the distance P between two adjacent poles. The magnetic pole is thus attached and the volume of conductive wire (volume of “copper”) is maximized.

### LIST OF REFERENCES IN THE FIGURES

Motor
Rotor 2
   Poles
   Magnet 3
   Axis 5
Stator 4
   Poles 12
   Magnetic armature 6
      First part 6a
      Second part 6b
         Tab 26
      Teeth 20
         Axial extensions 16a, 16b
         Free ends 18
      Recess 13
      Coil core 14 (p)
         Fastening part 14a
         Central part 14b
         Pole part→Tooth 20
   Coil 8
      Coil support 10
         Hollow central part 10a
         First flange 10b
         Second flange 10c
         Axial-positioning limit stop 11
         Locking clip 13
      Conductive wire 22
      Electrical terminals 24

Axial direction A

Axial height of the coil H

Axial height of the magnetized part of the rotor H″

Axial height of the copper C1, C2

Axial height of the teeth H′

Coil width L

Distance between poles P

Axial thickness of the magnetic core of the coil E

Diameter of the circumscribed circle of the magnetic circuit of the stator D

1-26. (canceled)

27. An electric motor comprising a rotor comprising a magnetized part defining a plurality of rotor poles, and a stator comprising a plurality of coils and a magnetic armature defining a magnetic circuit, each coil comprising a coil core, in the form of a separate preformed part made of a magnetic material fastened to the magnetic armature, the coil core comprising a tooth defining a magnetic pole of the stator, the tooth including extensions extending in an axial direction, a height (H′) of the tooth and a height (H) of the coil being comparable to a height (H″) of the magnetized part of the rotor, wherein the magnetic armature as well as the coil core are formed and cut out of metal sheets, a major plane (M) of the metal sheets being perpendicular to the axis of rotation (A) of the rotor, the extensions of the tooth being folded orthogonally on either side of the major plane (M).

28. The electric motor according to claim 27, wherein free ends of the tooth have a smaller width than a central part of the tooth.

29. The electric motor according to claim 27, wherein the magnetic armature comprises two identical metal sheets assembled opposite one another.

30. The motor according to claim 27, wherein the ratio of the diameter (D) of a circumscribed circle of the magnetic circuit to the height (H″) of the magnetized part is greater than three: D/H″>3.

31. The motor according to claim 27, wherein the ratio of the height H′ of the teeth to the thickness E of the main part of the magnetic armature is greater than three: H′/E>3.

32. The motor according to claim 27, wherein the motor has two phases and comprises two or four coils and eight magnetic poles on the stator.

33. The motor according to claim 27, wherein the motor has three phases and comprises three coils and nine magnetic poles on the stator.

34. The motor according to claim 27, wherein the number of magnetic poles of the stator is greater than the number of magnetic poles of the rotor.

35. The motor according to claim 27, wherein a distance (P) between adjacent coil poles is less than a maximum width (L) of the coil.

36. The motor according to claim 27, wherein the coil core and electrical terminals are overmolded with a coil support.

37. An electric motor comprising a rotor comprising a magnetized part defining a plurality of rotor poles, and a stator comprising a plurality of coils and a magnetic armature defining a magnetic circuit, each coil comprising a conductive wire wound around a coil support and a coil core, the core being in the form of a separate preformed part made of a magnetic material fastened to the magnetic armature and comprising a tooth defining a magnetic pole of the stator, the tooth including extensions extending in an axial direction, a height (H′) of the tooth and a height (H) of the coil being comparable to a height (H″) of the magnetized part of the rotor, wherein an axial thickness (E) of the core of the coil is less than half of an axial thickness (C1+C2) of a part of the coil wound with conductive wire.

38. The motor according to claim 37, wherein the ratio of a diameter (D) of a circumscribed circle of the magnetic circuit to the height (H″) of the magnetized part is greater than three: D/H″>3.

39. The motor according to claims 37, wherein the ratio of the height H′ of the teeth to the thickness E of the main part of the magnetic armature is greater than three: H′/E>3.

40. The motor according to claim 37, wherein the motor has two phases and comprises two or four coils and eight magnetic poles on the stator.

41. The motor according to claim 37, wherein the motor has three phases and comprises three coils and nine magnetic poles on the stator.

42. The motor according to claim 37, wherein the number of magnetic poles of the stator is greater than the number of magnetic poles of the rotor.

43. The motor according to claim 37, wherein a distance (P) between adjacent coil poles is less than a maximum width (L) of the coil.

44. The motor according to claim 37, wherein the coil core and electrical terminals are overmolded with a coil support.

45. An electric motor comprising a rotor comprising a magnetized part defining a plurality of rotor poles, and a stator comprising a plurality of coils and a magnetic armature defining a magnetic circuit, each coil comprising a coil support with a hollow central part bordered with a first flange at one end and a second flange at the other end, and a coil core in the form of a separate preformed part made of a magnetic material fastened to the magnetic armature, the coil core comprising a tooth defining a magnetic pole of the stator, the tooth including extensions extending in an axial direction, a height (H′) of the tooth and a height (H) of the coil being comparable to a height (H″) of the magnetized part of the rotor, wherein the coil is assembled with its magnetic core axially in a recess of the magnetic armature, the flanges cooperating with edge parts of the recess to position the coil in the axial direction and in a plane orthogonal to the axial direction, in the magnetic armature.

46. The motor according to claim 45, wherein the ratio of the diameter (D) of a circumscribed circle of the magnetic circuit to the height (H″) of the magnetized part is greater than three: D/H″>3.

47. The motor according to claim 45, wherein the ratio of the height H′ of the teeth to the thickness E of the main part of the magnetic armature is greater than three: H′/E>3.

48. The motor according to claim 45, wherein the motor has two phases and comprises two or four coils and eight magnetic poles on the stator.

49. The motor according to claim 45, wherein the motor has three phases and comprises three coils and nine magnetic poles on the stator.

50. The motor according to claim 45, wherein the number of magnetic poles of the stator is greater than the number of magnetic poles of the rotor.

51. The motor according to claim 45, wherein a distance (P) between adjacent coil poles is less than a maximum width (L) of the coil.

52. The motor according to claim 45, wherein the coil core and electrical terminals are overmolded with a coil support.
